(19) United States
(12) Patent Application Publication
(10) Pub. No.: US 2025/0077897 A1
(43) Pub. Date: Mar. 6, 2025

(54) SPARSE FEATURE ENCODING OF MULTIMODAL DATA TO BUILD COMMONSENSE KNOWLEDGE ONTOLOGY SUPPORTING DEDUCTIVE REASONING SYSTEM

(71) Applicant: Through Sensing, LLC., Arlington, VA (US)

(72) Inventor: Andrew R. KALUKIN, Arlington, VA (US)

(73) Assignee: Through Sensing, LLC., Arlington, VA (US)

(21) Appl. No.: 18/420,865

(22) Filed: Jan. 24, 2024

Related U.S. Application Data
(60) Provisional application No. 63/580,725, filed on Sep. 6, 2023.

(51) Int. Cl. G06N 5/02; G06N 5/04; G06V 20/40

(52) U.S. Cl. CPC G06N 5/02; G06N 5/04; G06V 20/41; G06V 20/49; G06V 2201/12

(57) ABSTRACT

Systems and methods for answering queries by applying deductive reasoning using a data structure based on knowledge derived from sensory data are provided. A method may include acquiring multimodal sensory data and extracting a plurality of salient features of the one or more objects. Data structures that associate one or more essential characteristics with each of the plurality of salient features may be created and the spatial relationships among the one or more objects in visual scenes may be mapped. An ontology that encompasses the typical relationships among the classes of objects in a plurality of datasets may be created and one or more axioms may be established.

### BACKGROUND

Artificial (AI) systems have become increasingly prevalent in a variety of industries and contexts. Often AI systems use deductive reasoning in order to come up with answers to specific queries based on broad databases of information. However, existing artificial intelligence (AI) systems are unable to use highly detailed real-world knowledge such as humans use to solve problems, and rely instead almost entirely on data sets and databases built manually or from text input, without any additional contextual information. This means those existing systems may be inflexible and may come up with incorrect or inefficient solutions to real-life problems. Some of the deficiencies in knowledge can be mitigated through a process of ontological engineering to fill in the gaps in knowledge manually, but this process is labor-intensive and expensive.

Additionally, many AI system datasets depend on the internet and large language models. Systems dependent on these sources may suffer from a plurality of issues such as data hallucination, accidental bias, susceptibility to deliberately poisoned training data, inability to explain conclusions, and/or erroneous reasoning due to insufficient background knowledge and lack of an underlying geometrical physical model of the world. Current strategies for mitigating these problems have often involved increasing the amount of training, extending the size and diversity of training datasets, increasing the security protections over training datasets, and structuring the AI queries to focus the AI responses. These kinds of strategies have been shown to be useful but are not yet effective in solving the problems.

Some current solutions include using multimodal training data, for example, a combination of text and image data, to train AI systems to associate objects in the physical world with text and language. This strategy can be effective when the relationships among entities in the image data and text are straightforward. However, if the number of objects in either medium is large and if the spatial or conceptual relationships are complex or abstract, the AI system may not understand the salient features for classifying related objects into a common category or distinguishing objects that should be considered distinct. Furthermore, this process is expensive, time-consuming, and labor-intensive.

In contrast to many AI systems, humans can grasp salient features of a concept or problem from one or a few examples. The advantage that humans have over AI systems is commonsense knowledge based on experience and interaction with the physical world. Commonsense knowledge provides context for understanding new information. Commonsense knowledge is grounded in physical experience that includes external information from the outside world derived from the senses as well as internal information about the physical body derived from proprioception, kinesthetics, and similar internal sensory sources.

Though some existing robotic devices can navigate using visual information and internal sensors that give them a sense of their own orientation, and can identify objects and obstacles in their path, there are no devices that apply this information to build a commonsense understanding of the world in the form of a highly detailed ontology or knowledge graph. The term ontology is used here to mean a formal description of concepts, relationships, connections, properties, and rules within a knowledge domain. Ontology elements are often visually depicted using a knowledge graph data structure in which nodes or vertices represent concepts or classes, and edges connect the nodes and map the relationships between these nodes. The ontology knowledge graph can be mined for information, using information graph retrieval processes such as recursive subgraph searching and matching, and deductive reasoning on axioms in the ontology using an automated theorem prover, to answer questions about a large variety of topics.

The ability to develop such an ontology or knowledge graph from physical sensory data requires several processes, including identifying salient features and objects in the data, mapping the relationships among the features in a knowledge graph, and mining the information from the graph in response to queries or navigational requirements. A process commonly used for object identification in visual data is semantic segmentation, which identifies the class of object corresponding to specific pixels. Though semantic segmentation can be used to extract information about the kinds of objects that may be in a scene, it does not in itself map the relationship among objects. That is, existing algorithms can identify objects in visual data, but in most cases cannot answer detailed questions about where the objects are, or how they are oriented with respect to other objects.

Furthermore, the information derived by semantic segmentation from a specific instance, for example an image frame, is not automatically generalized to a category; that is, semantic segmentation does not in itself provide a means for the AI device to state the distinguishing features of the objects that define their category. For example, the result of a semantic segmentation process on an image of a group of shrubs might result in tagging each green pixel as a leaf pixel; but this result does not give all the information about the distinguishing characteristics of shrubs in general. Existing AI algorithms such as machine learning can learn from numerous image examples of shrubs and non-shrubs to identify images containing shrubs, and even to identify the pixels that are shrub pixels in a specific image, but this capability does not in itself include the ability to articulate in plain language, for example through a natural language interface, the general characteristics and features that differentiate shrubs from non-shrubs.

The ability to derive general categories from a few instances or examples requires an ability to cluster similar objects and distinguish different objects in a knowledge graph or ontology that can be mined through queries. Some existing AI methods may have the ability to separate divergent classes of objects and cluster similar objects in mathematical multidimensional spaces, but the AI models cannot articulate through a natural language interface in plain language a summary or explanation of the differentiating features.

### SUMMARY

In one or more embodiments a method and system for answering queries using deductive reasoning may be shown and described. An exemplary method may include acquiring multimodal sensory data and extracting a plurality of salient features of the one or more objects. Data structures that associate one or more essential characteristics with each of the plurality of salient features may be created and the spatial relationships among the one or more objects in visual scenes may be mapped. An ontology that encompasses the typical relationships among the classes of objects in a plurality of datasets may be created and one or more axioms may be established.

An exemplary system for answering queries by applying deductive reasoning using a data structure based on knowledge derived from sensory data may include one or more sensors that capture multimodal sensory data. The system may further include an extraction module that extracts a plurality of salient features of the one or more objects at one or more levels of spatial resolution or structural hierarchy, a data structure module that associates one or more essential characteristics with each of the plurality of the plurality of salient features, creates data structures that associate one or more essential characteristics with each of the plurality of salient features, and maps the spatial relationships among the one or more objects in visual scenes at multiple levels of spatial resolution or structural hierarchy recursively to capture the part-whole relationships of the objects and one or more object components, and an ontology module that builds an ontology that encompasses the typical relationships among the classes of objects in a plurality of datasets, and establishes one or more axioms that encode the specific relationships of individual datasets and the general relationships of classes of objects from multiple data examples. Finally a deductive reasoning tool that is applied to the axioms of the ontology and searches graph-based structures of the ontology to output identifying information and relationship information on at least one of the one or more objects may be included.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is an exemplary method for determining ontological attributes of images.

FIG. 2 is an exemplary deductive reasoning system.

FIG. 3 is an exemplary flowchart related to an embodiment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

In one or more exemplary embodiments a robotic system for providing an Artificial Intelligence (AI) deductive reasoning system may be provided.

In an exemplary embodiment the robotic system may include a plurality of sensors, for example but not limited to cameras, audio recorders, temperature sensors, UV sensors, olfactory sensors, etc. The sensors may be able to collect a plurality of sensory data from which can be extracted information related to its inherent spatial and spectral attributes that help identify structural, ontological, taxonomical, topological, geometrical, and other conceptual features. In some embodiment input data may also be, for example, synthetic, drawn, or cartoon representations of physical or abstract objects. The sensors may be deployed on a plurality of platforms, including, for example but not limited to, unmanned aerial vehicles, unmanned underwater vehicles, unmanned ground vehicles, satellites, or stationary platforms.

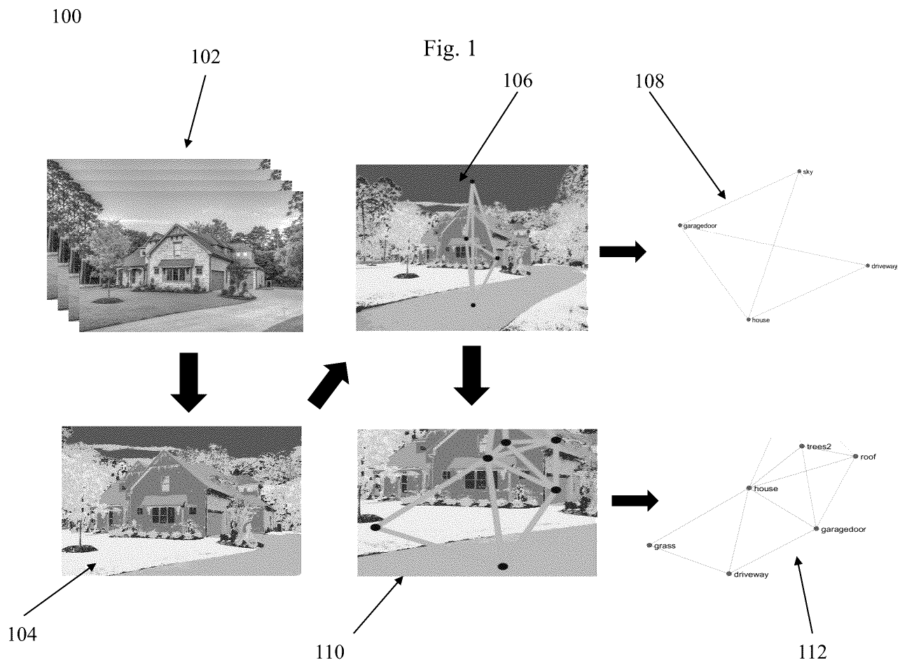

Referring now to FIG. 1 an exemplary method for determining ontological attributes of images 100 may be described. In a first step 102 one or more images and/or videos from an image datastore may be analyzed. The one or more images and/or video may come from, for example, an external data source such as the internet, or may be captured directly by a plurality of sensors or cameras, for example on the robotic system. In a next step 104 the one or more images may undergo a process of semantic segmentation such that objects are separated from the background and each other. In a next step 106 a single-scene region adjacency graph (or scene graph) at coarse resolution may be generated, that is, the largest objects and scene elements may be identified. For example, as shown in step 108, a house, driveway, sky, and garage door may be identified from an exemplary image. In a next step 110, smaller components may be mapped in more detail at a lower level of hierarchy in order to obtain a more detailed view of subregions or components of the one or more images. For example, as shown in step 112, at a lower level additional items such as trees or a roof may be identified. Additional topological, taxonomical, hierarchical, and geometrical information and relations may be extracted from the increasingly detailed mappings. In some embodiments a plurality of supervised and/or unsupervised mathematical and computer vision methods, for example, a statistical clustering method such as k-means clustering, texture matching, automated target recognition, or some other image processing technique for semantic segmentation, may be utilized in the process of extracting objects and their components.

Semantic segmentation may be applied to 2D and/or 3D image models for determining spatial reasoning about shape and color based on, for example, shadows and shading, illumination direction, structure from motion, a priori knowledge of objects in scenes, and/or other physically-based reasoning techniques. The features obtained by these methods may be used in building the ontology and in establishing the identities and relationships of the objects in the image data.

It may be understood that step 110 may be repeated additional times depending on the situation, in order to obtain more and more detail and granularity in image recognition and allow for multiple spatial scales for determining relations between objects. Additionally, part-whole relationships may be determined from the derived multiscale graphical constructs. It may be understood that this recursive process may have a natural stopping point at the spatial resolution of the smallest image feature, that is, a meaningful identifying part of the subject or target in the image, for example, eyes or hands on images of people. As an additional step the obtained data may be encoded into a graph form that shows the relationships between the individual parts and the whole, for example, a bounding value hierarchy tree structure which maps the relationship of objects to the volumes which contain them. Essential relationships for new objects may then be determined based on the scene topology, and computer vision techniques may be applied to motion imagery and change detection (for example in a video or sequence of images) to characterize behavior of new objects. The method may then return to step 102 for each additional image and/or video there may be.

It may be understood that the transformation of input pixel data into features through semantic segmentation and mapping the adjacency and other properties of these features using a region adjacency graph or scene graph is inherently a compression process—that is, each component in the image that may have occupied many pixels in the original data may be represented by a few bytes that show its attributes. For example, in an exemplary embodiment the component's attributes may be represented as data fields associated with each component's node in the graph, and its connectivity to other vertices as data fields or weights associated with each edge. Potential attributes for each node may be physical or material properties; mean state, variance, or other statistical or quantitative properties; or any other kind of information that might be encoded. Potential attributes for each edge might be distance, relative direction, or some indicator as to whether one of the entities is partially or fully contained in the other. Various compression schemes may be used to represent the compressed data, for example, a sparse matrix representation in which only nonzero items are stored in the region adjacency graph. The data compression described above may enable implementation on an edge device such as a drone or robot, enable AI that is independent of internet and cloud sources of information, and/or enable autonomous navigation by applying the principles described above to a geospatial ontology data structure that functions as a global navigation map. In some exemplary embodiments of the invention, the autonomous navigation capability may be integrated with other navigational aids, for example the Global Positioning System (GPS), as a supplemental guide or backup replacement when the other means of navigation are unavailable. This kind of navigational aid may have supplemental applications, for example, recognizing landmarks under unusual orientations or points of view which often cause existing computer vision target recognition algorithms to fail.

In another embodiment a variety of topological relationships between different scene elements may be mapped utilizing, for example, image processing constructs such as region adjacency graphs or scene graphs, connected components image processing algorithms, and other set theoretical and image processing methods at multiple spatial scales and successive levels of hierarchy using the recursive process described in FIG. 1. In some embodiments geometrical information available in image samples may be utilized to encode spatial characteristics at multiple spatial scales into formats suitable for taxonomies and ontologies, which may drive an inference or deductive reasoning engine to automate reasoning and/or develop hypotheses. Additional abstract features of objects and their parts, for example lattice structure, repeated patterns, fractal dimensions, and other mathematical patterns and texture types may be associated with the object graph edges and vertices as data fields, and may be derived from sensory data. The edge and vertex data may further be utilized for concepts such as cardinality and ordinality, which allow for answers to queries related to order, orientation, and quantity. In some embodiments visual and scene data may be combined with other data from one or more sensors such as, for example, spectral, olfactory, proprioception, auditory, or environmental sensors, in order to synthesize additional abstract concepts.

In some embodiments typical object motion may be defined in a 3D model space by utilizing a fourth dimension representing change in time for the vertices and edges in its hierarchical, multiscale graphs, which may allow for accounting for temporal relations between objects, such as but not limited to causation, lag, before/after correlations, flow, and developmental change in general. In some embodiments hybrid graphs for representing visual ontology may be used. Hybrid graphs may include, for example but not limited to, network graphs, 3D models, 2D models, mosaics of 2D or 3D models, 2D+time, 3D+time, phase space (velocity and position) and/or multidimensional models where two or three dimensions may be spatial or one dimension in time. It may be understood that the graphs may be able to represent changes in entities over time, for example, the growth of trees and flowers as viewed in a series of time-lapse image or video frames.

Using the encoded graphing methodologies and multiscale resolution imaging techniques a plurality of object definitions and attributes may be determined, as described below.

Over time concepts in the ontology pertaining to tangible, physical objects (for example house, tree, driveway, etc.) may be defined by their persistent topological relationships to the overall scene and other associated objects within the scene. Therefore, it may be understood that the definition of words related to tangible physical objects may be formed in a way that is independent from an explicit dictionary definition and/or statistical associations determined from corpuses of documents. Intangible objects on the other hand may be defined through, for example, developing a graph defining taxonomical relation to physical objects, creating a data structure and processing capability that may be seen as analogous to a metaphor.

Several examples are provided to illustrate how this method may be used to develop the system's understanding of intangible objects. If the system is shown a series of images depicting the growth of a mushroom and the series is annotated as “growth,” the system may associate with the term “growth” the expansion over time of some object. The representation of “growth” may be of any form, either a series of numbers representing some measurement, a series of vectors representing dilation or contraction or flow, and so on. If the system is shown a depiction of a pile of money in a safe, and a series of depictions of the growth of the pile representing accumulation, it may be understood to understand the concept of growth abstractly as it pertains to dilative change of anything over time, and not associated only with specific physical entities; and similarly with the concept of “loss.” By associating a concept such as growth with a physical entity that can modeled, it may be understood that a deductive reasoning device using the ontology would be able to reason about examples of growth and the opposite concept of loss in unrelated situations the device has not previously encountered.

Another example of intangible concept that may be communicated into practical understanding may be the notion of “containment.” For example, an image of a 2D ring as the outer boundary of a circle (for example, a 2D image of a donut and its hole). Topological processing to determine connected components may group the circle pixels into one set, and inform the system that the ring acts as the boundary of the circle. When the objects are translated into graph features, the notion of “containment” may be embedded in the graph structure, and the same notion may then be applied to any kind of shape where an outer object bounds an interior one. This may provide a way for the system to reason about any situation involving containment, which may be generalized to other similar concepts like “imprisonment,” “entrapment,” “sequestration,” and “storage.” In so doing, the system may apply the same methodologies it uses for mapping relationships among physical objects and class types to abstract categories. As in the previous example, the physical basis of the containment image example enables reasoning about containment concepts in other unrelated contexts.

Additional notions about idealized scale, orientation, motion, rotation, orbit, distance, color, and positional attributes for conventional representative objects may be inferred by applying information from the ontology and constraints from the deductive reasoning engine. Physical concepts of an ideal object, including but not limited to material type, volume, area, pressure, weight, speed, and/or acceleration, may be derived from sensory data and deductive reasoning from constraints and a priori knowledge, which may be acquired, for example, through a separate process that may be explicitly programmed, or through operator-assisted acquisition. In some embodiments spatial reasoning may be applied to the graphs to make determinations related to occlusion and hidden surfaces.

It may be understood that the method described in FIG. 1 may be able to translate visual image data and/or video into concepts that may be processed by additional systems or methods, for example a natural language processing system.

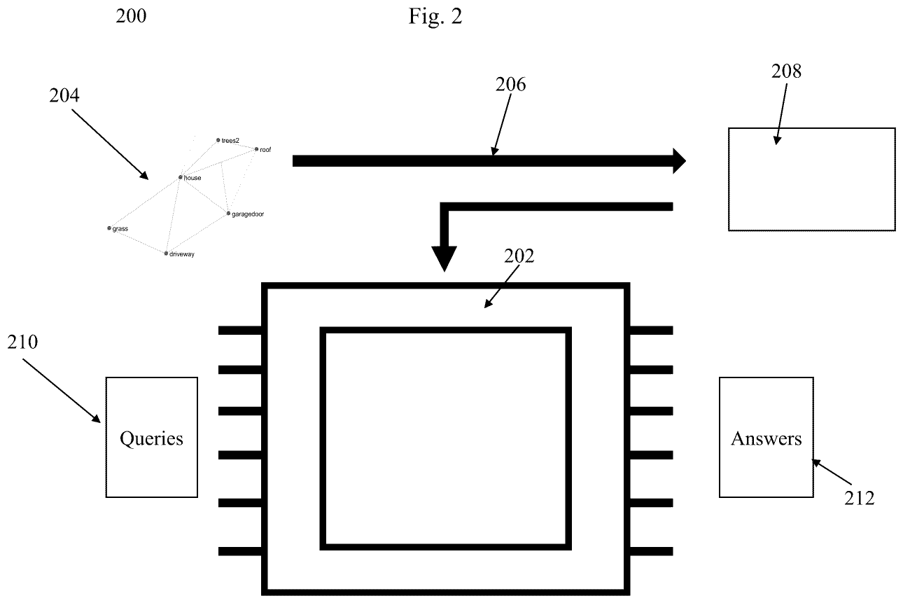

Referring now to FIG. 2 an exemplary deductive reasoning engine 202 may be described. The deductive reasoning engine 202 may be, for example, a processor or computer system. The deductive reasoning engine 202 may build deductions from a commonsense knowledge ontology based on hierarchical, multiresolution semantic segmentation of sensory data, such as described in the method 100, in order to answer queries and/or generate conjectures. The deductive reasoning engine 202 may take as an input one or more abstract ontology graphs 204. In some embodiments several of the ontology graphs 204 may be related, for example a second graph may be a more detailed version or a higher resolution version of a first graph. In some embodiments the abstract ontology graphs 204 may be reformatted, using a process 206 that extracts graph features, into classes of objects 208 for input into the deductive reasoning engine 202. The classes of objects 208 may be, for example, in a JSON format, in other embodiments an alternative format may be used, for example but not limited to XML and CSV, web ontology languages such as OWL, graph data storage frameworks, and databases in general; any method of representing classes of objects and their attributes may be applied. The deductive reasoning engine 202 may then be fed with a plurality of queries 210, for example “what is often adjacent to houses”. The deductive reasoning engine 202 may use the granular commonsense knowledge ontology, obtained for example through the method 100, to answer queries and generate a plurality of conjectures 212. For example, the conjecture corresponding to the query “what is often adjacent to houses” may be “grass, trees, and a driveway”. It may be understood that unlike a conventional knowledge graph or large language model, the information in this ontology has been derived from sensory data, and the evidence of the invention's conjectures and conclusions is traceable to the physical data sources and its deductive chain of reasoning.

It may be understood that through the method 100 the deductive reasoning engine 202 may continue to develop and refine an understanding and view of the world through physical interactions. Through the reasoning and method described the deductive reasoning engine 202 may be able to make physical predictions about typical commonplace objects based on commonsense knowledge acquired directly through physical input. The predictions may take physical and material properties into account, for example but not limited to, gravity, light scattering, specular/diffuse reflection, attenuation, transmission, and temperature.

Through spatial reasoning, image processing, and mathematical topology methods applied to maps and image data the deductive reasoning engine 202 may be able to answer queries related to path navigation, road connectivity, line of sight, and/or other geometrical or geographic physical information. Through spatial reasoning applied to multiscale hierarchical graphs for people and animals, the deductive reasoning engine 202 may be able to answer queries related to, for example, general pose and posture of people or animals. In exemplary embodiments systems may utilize the information they derive from these methods to explain general observations about the classes of entities in the image data, and generalize their conclusions beyond the information from one image by using the aggregation methods described above to explain differences and similarities among classes of objects, communicate these observations through natural language, and deductively reason about their significance in other contexts.

In some embodiments spatial reasoning may be accomplished as an optimization function. Given an image containing a set of components for which a hypothetical identification has been made about each component, the system may build a model that accounts for hidden surfaces or the identity of hard-to-identify components through a plurality of ways. In one embodiment a “bottom up” method may be used, which may be to make assumptions about the identity of each part and score the possible models using a function that measures the consistency of identifications against the best-fit model or conjecture that explains the whole image. In another embodiment a “top down” method may be used, which may be to make an assumption about the image content, make a hypothesis about each of the components, and score the consistency of each hypothetical identification against the global hypothesis. It may be understood that these are not mutually exclusive strategies, and in some embodiments the system may iterate between making the best guess about local components and making the best guess about the overall image content. As a specific example, suppose there is an image of a man standing behind an automobile, and three of the wheels of the car are showing, with just the man's torso visible over the hood. The identification of the human face, the wheels, and other visible parts of the car may have been made with high confidence. The hypothesis that the scene content includes the presence of a man may be strengthened if legs were visible, but they are not; and the hypothesis that the scene content was a car would be strengthened if occluded features of that were visible. By using a mechanism in which possible arrangements of man and automobile in the scene are scored against the actual measurements of each component's location, it may be possible for a deductive spatial reasoning tool to arrive at an optimal hypothesis of the configuration of the man and the automobile and other elements in the scene. All the hypotheses and conjectures to determine the scene content in this example may be understood to be enabled by the ontology and visual deductive reasoning, using steps described in the following paragraphs. It may be noted that the ontology and visual deductive reasoning processes do not require explicit AI or machine learning training or models for any stage of its operation. However, embodiments of the invention may be developed to integrate AI or machine learning for some operations which include information and models derived from large language models or the internet.

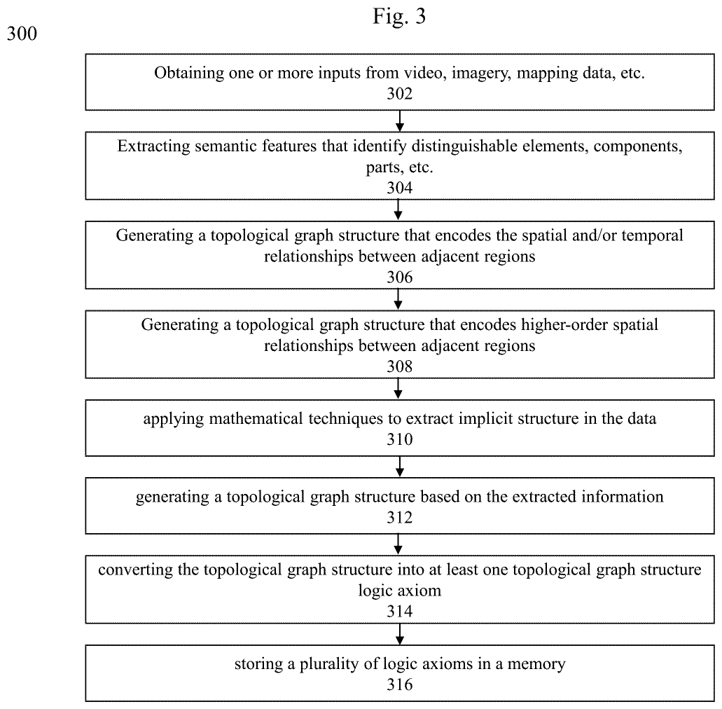

Referring now to FIG. 3, an exemplary method for populating a commonsense knowledge base of an AI system that answers questions from human users, develops hypotheses, reasons deductively from premises, solves word problems, carries out spatial reasoning, and converses intelligently with humans may be provided. It may be understood that the method may be carried out by, for example the robotic system 200, another computing device, and/or a processor.

In a first step 302 the method may begin with obtaining one or more inputs from video, imagery, mapping data, 2D or 3D computer models, architectural design, electronic schematics, or other 2D or 3D data formats. In a next step 304 semantic features that identify distinguishable elements, components, parts, sections, or regions in the input data may be identified using mathematical and image processing methods such as semantic segmentation; k-means, vector quantization and other data clustering methods; digital discretization; thresholding of intensity levels; multispectral or hyperspectral processing; and texture characteristics such as measured by multiresolution mean, variance, and similar statistics, wavelet processing, texture occurrence and cooccurrence metrics, fractal number metrics, Fourier power spectra of spatial region etc.

In a next step 306 a topological graph structure may be generated that encodes the spatial and/or temporal relationships between the adjacent regions, using mathematical graph methods such as region adjacency graphs or scene graphs, where “relationships” refer to relative positional characteristics such as adjacency, connectivity, inside/outside, orientation, above/below, right/left, and so on, between pairs of regions or features in the data. In a next step 308 a topological graph structure that encodes higher-order spatial relationships between adjacent regions (where “higher-order” refers to relative positional characteristics among three or more regions or features in the data) may be generated. In a next step 310 implicit structure in the data may be extracted using mathematical and visual reasoning techniques such as set theory, graph theory, and optimization. The implicit structure may be, for example but not limited to, 3D structure as evidenced by parallax in images; detection of an occluded object by detecting one or more parts or features of it; structure from shading; discovery of shadows and application of that knowledge to determine ambient illumination, 3D structure, and other information content not immediately detectable in the input data, but calculated using inference engine techniques applied to the knowledge base.

In a next step 312 the system may generate a topological graph structure based on the extracted information. In a next step 314 the system may convert the topological graph structure into at least one topological graph structure logic axiom suitable for subsequent processing by an automated theorem prover or deductive reasoning program. In a final step 316 the system may store one or more logic axioms in, for example, a memory structure such as a table or database. The one or more logic axioms stored in memory may include at least one topological graph structure logic axiom, which may be understood to be at least first-order level logic axioms. Each logic axiom may encode commonsense assumptions required to formulate answers to questions or to generate hypotheses about the image scene or other data. Thus, it may be understood that a commonsense database may be generated.

It may be understood that in some embodiments the system may parse additional extrinsic information and geometric transformations (either random or patterned, consisting of manipulations of shape, rotation, size, position, and so on) on the spatial data to formulate and test one or more conjectures based on the further extrinsic information. In an exemplary embodiment, the system may be asked whether a wheelbarrow will fit through a door, the system may then use visual reasoning to consider various orientations in 3D space to answer the question, using its ontology and the deductive reasoning capabilities described above. The conjectures may include a hypothesis logic axiom of at least first-order logic, and the one or more may be formulated or tested by generating the hypothesis logic axiom to be tested against the plurality of logic axioms contained in the knowledge base to generate a conjecture test result, the conjecture test result being an indication either that the conjecture is provable as true, provable as false, or not provable as either true or false. In some embodiments conjectures that are provable as true may be stored in the knowledge base as an ontology element, or an axiom in an inference engine, automated theorem prover, or other similar automated deductive reasoning engine. In some embodiments conjectures that are not provable as true may be used to formulate and test additional conjectures, and may map the subsequent truth or falsity into the knowledge base.

In some embodiments data fusion of multimodal data types may be used to enhance the feature extraction when input data is received from multiple sources. For example, sound may be associated with a particular visual feature in a video, and those associations may be used to enhance the knowledge base. In some embodiments the method 300 may be used to process data spanning a time interval, for example, imagery or video collected over multiple time periods, and may extract temporal features such as change and growth, and associate the temporal features with the extracted visual and other sensory features in the knowledge base.

The description of the exemplary embodiments in the preceding paragraphs outline the procedures for developing a general understanding of classes of objects derived from multiple individual examples. In some embodiments, the system may further access individual examples in its data store to justify its conclusions or general understanding about classes of objects. For example, if the invention were shown several examples of images of apples and oranges, it would be able to deduce that the differences between the classes of fruit were mainly evidenced in color, and to some degree in shape. The invention would also be able to articulate those differences in plain language through a natural language interface. In addition, in some potential embodiments, the invention would be able to retrieve example images of apples and oranges from the data store it used to generate its hypotheses, and provide these specific image examples as evidence supporting its conclusions.

It may be contemplated that in some embodiments the above system and methods may be applied to various applications. For example, in a first embodiment the above systems and method may be applied as a seeing aid for the blind, and may include image or video camera systems which apply the above to process data to provide a navigational tool for a blind user. Such a tool may be understood to have advantages compared to present state of the art in that it may enable interactive queries through auditory mechanisms and spoken language that would allow a blind user to ask detailed information about the location of potential obstacles, and other questions that require commonsense understanding of a visual scene and visual deductive reasoning capabilities unavailable in many contemporary AI implementations. In the embodiment it may be further considered to use natural language input and output for communication between the user and system, for example in order to provide auditory directions.

In a second embodiment the above systems and methods may be applied to find the solution to a word problem posed to the system through, for example, text or a natural language input. The word problem may be, for example but not limited to, physical, mathematical, geometrical, etc. in nature. The system may solve the problem by generating an artificial virtual scene (possibly 2D or 3D) reflecting the logical hypothetical relationships among the elements in the word problem, and may manipulate elements in the virtual scene to populate the knowledge base, and subsequently may use an inference engine on the knowledge base to generate an answer to the posed word problem; and may output an answer through text, natural language, imagery, graph, or some other form of output. These operations of the invention may not depend on AI training or machine learning, which are often attempted by contemporary AI models to solve word problems.

In a third embodiment the above systems and method may be applied to allow the system to overcome various cyber-security schemes, for example to overcome Captcha or similar systems, or to invent countermeasures to strengthen Captcha and other cyber-security schemes. For example, the invention may be used to apply visual reasoning to the scene elements in Captcha and apply its ontology to determine the presence of object parts and components that may identify a Captcha object, apply visual reasoning to determine occlusion of an object, and detect the presence of an object from unusual points of view. It may be understood that these embodiments are exemplary and the methods and systems described may be utilized in a plurality of other circumstances.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for answering queries by applying deductive reasoning using a data structure based on knowledge derived from sensory data, comprising:
acquiring multimodal sensory data including one or more objects;
extracting a plurality of salient features of the one or more objects at one or more levels of spatial resolution or structural hierarchy;
creating data structures that associate one or more essential characteristics with each of the plurality of salient features;
mapping the spatial relationships among the one or more objects in visual scenes at multiple levels of spatial resolution or structural hierarchy recursively to capture the part-whole relationships of the objects and one or more object components;
building an ontology that encompasses the typical relationships among the classes of objects in a plurality of datasets;
establishing one or more axioms that encode the specific relationships of individual datasets and the general relationships of classes of objects from multiple data examples;
applying a deductive reasoning tool to the axioms of the ontology;
searching graph-based structures of the ontology; and
outputting identifying information and relationship information on at least one of the one or more objects.

2. The method of claim 1, further comprising receiving one or more queries; and
answering the one or more queries by the deductive reasoning tool based on the outputted identifying information and relationship information.

3. The method of claim 2, wherein the multimodal sensory data includes one or more of visible light images, video, sound recordings, radar signals, infrared and ultraviolet images, and physical measurements.

4. The method of claim 2, wherein the plurality of salient features of the one or more objects are extracted via one or more of computer vision, image processing, or statistical methods.

5. The method of claim 2, wherein the one or more essential characteristics include at least one of color and material composition.

6. The method of claim 2, wherein the spatial relationship among the one or more objects is mapped utilizing a mathematical topology principle and the part-whole relationships of the objects are captured based on region adjacency graphs or scene graphs.

7. The method of claim 2, wherein the deductive reasoning tool is an automated theorem prover.

8. The method of claim 2, wherein the one or more queries are addressed through a natural language interface; and
wherein the answer is determined by at least an artificial intelligence or machine learning device.

9. The method of claim 8, further comprising applying the method to a mathematical word problem or other problem that requires visualization.

10. The method of claim 8, further comprising applying the method to an alternative AI method; and
constraining the alternative AI method to reduce or prevent data hallucination, bias, irrelevant conclusions, and/or AI misbehavior.

11. The method of claim 10, wherein the alternative AI method is a large language model or a small language model.

12. A system for answering queries by applying deductive reasoning using a data structure based on knowledge derived from sensory data, comprising;
one or more sensors that capture multimodal sensory data;
an extraction module that extracts a plurality of salient features of the one or more objects at one or more levels of spatial resolution or structural hierarchy;
a data structure module that associates one or more essential characteristics with each of the plurality of the plurality of salient features, creates data structures that associate one or more essential characteristics with each of the plurality of salient features, and maps the spatial relationships among the one or more objects in visual scenes at multiple levels of spatial resolution or structural hierarchy recursively to capture the part-whole relationships of the objects and one or more object components;
an ontology module that builds an ontology that encompasses the typical relationships among the classes of objects in a plurality of datasets, and establishes one or more axioms that encode the specific relationships of individual datasets and the general relationships of classes of objects from multiple data examples;
a deductive reasoning tool that is applied to the axioms of the ontology and searches graph-based structures of the ontology to output identifying information and relationship information on at least one of the one or more objects.

13. The system of claim 12, wherein the deductive reasoning tool further receives one or more queries and answers the one or more queries based on the output identifying information and relationship information.

14. The system of claim 13, wherein the multimodal sensory data includes one or more of visible light images, video, sound recordings, radar signals, infrared and ultraviolet images, and physical measurements.

15. The system of claim 14, wherein the plurality of salient features of the one or more objects are extracted via one or more of computer vision, image processing, or statistical methods.

16. The system of claim 12, wherein the one or more sensors are integrated into one of an unmanned ground vehicle, unmanned aerial vehicle, or unmanned underwater vehicle.

17. The system of claim 16, wherein the unmanned ground vehicle, unmanned aerial vehicle, or unmanned underwater vehicle is configured to navigate autonomously based on the output identifying information and relationship information.

18. The system of claim 17, wherein the unmanned ground vehicle, unmanned aerial vehicle, or unmanned underwater vehicle is configured to use a sorting or search algorithm for the features in the ontology module for visual reasoning in order to obtain an understanding of geography of a region or environment.

19. The system of claim 18, wherein the unmanned ground vehicle, unmanned aerial vehicle, or unmanned underwater vehicle is further configured to determine the location of a perceived object or class of objects in geographical coordinates.
